(19) United States
(12) Patent Application Publication
(10) Pub. No.: US 2016/0174105 A1
(43) Pub. Date: Jun. 16, 2016

(54) Method And Device For Transmitting Data And Method And Device For Transmitting An Identification Signal

(71) Applicant: ZF FRIEDRICHSHAFEN AG, Friedrichshafen (DE)

(72) Inventor: Alexander GRAF, FRIEDRICHSHAFEN (DE)

(73) Assignee: ZF Friedrichshafen AG, FRIEDRICHSHAFEN (DE)

(21) Appl. No.: 14/904,857

(22) PCT Filed: Jun. 16, 2014
(86) PCT No.: PCT/EP2014/062506

§ 371 Date: Jan. 13, 2016

(30) Foreign Application Priority Data
Jul. 17, 2013 (DE) 10 2013 214 005.3

(51) Int. Cl. H04W 28/10; H04W 74/08; H04L 12/911

(52) U.S. Cl. CPC H04W 28/10; H04L 47/745; H04W 74/0816

(57) ABSTRACT

In a method for transmitting data from a transmitting station by means of a data transmission channels the data are transmitted in response to an identification signal which represents the information about a free data transmission capacity of the data transmission channel.

The present invention relates to a method and a device for transmitting data and a method and a device for transmitting an identification signal.

Wireless switches and other high-frequency devices often use ISM bands (ISM; industrial, scientific and medical) for data transmission. Due to the fact that these ISM bands can be used without a license, wireless devices whose respective applications preferably work in this band often meet with each other. In the case of competing operators it may also be their own product.

The statutory requirements for the use, for example, of the 868 MHz ISM band establish a maximum use of 1% of the time (1%-duty cycle) or an LBT operation (LBT; Listen Before Talk=listen first, then speak). Because of this 1%-duty cycle, every channel available from each station or each mobile subscriber must be kept free for about 99% so that data collisions occur with a lower probability.

In order to further reduce the probability of a disturbed transmission, in the prior art are known (possibly multiple) repetitions of transmissions with fixed and random wait intervals and the use of LBT operation For example, an LBT protocol is used to ensure the transmission. In such an LBT protocol, the radio switch wishing to transmit first listens into the channel and determines whether it is free. Only when it detects a free channel, it starts to transmit its data.

Against this background, the present invention provides an improved method for transmitting data and a corresponding device and an improved method for transmitting an identification signal according to the independent claims. Advantageous embodiments result from the dependent claims and the description below.

Transmitting data from a transmitting station in response to an identification signal of a free data transmission capacity in a data transmission channel sent by a receiving station increases the probability of a successful transmission with simultaneously reduced power consumption compared to a normal LBT process.

According to the concept presented here, for example, a data transmission from an autonomous wireless switch to a receiving station can be assured, where the wireless switch can largely manage with energy demand without the need for retransmissions but fully provide the benefits of an LBT protocol. The radio pulses to be transmitted can thus be designed accordingly shorter, which in turn allows to keep the load of the ISM band low. As a result, the duration of a channel assignment or the duration of an intended wait interval of a mobile subscriber can be advantageously reduced so that the limited energy supply, for example, of a radio switch need not be reduced too far.

Advantageously, the implementation of the proposed approach can effectively reduce the probability of data collisions in ISM bands and similar frequency ranges, even if in the future more and more participants will use these bands, which can be assumed. Many wireless devices in a vicinity of a given radio channel can thus use them without necessarily leading to the fact that the channel is busy a long time. Also, a number of repeats by a wireless device can be reduced, because less transmission interference can be expected due to the band load relief achieved according to the invention.

In a method for transmitting data from a transmitting station by a data transmission channel, the data is transmitted in response to an identification signal that represents information about a free data transfer capacity of the data transmission channel.

The transmission of the data can take place by radio in a predetermined frequency range. The data transmission channel can be one of several frequency bands in the frequency range, which are suitable for transmission of the data. The transmitting station can be, for example, an autonomous wireless switch or other device that is configured to send data by radio and alternatively also receive it. The identification signal can be a radio signal which can be received from the transmitting station over the same communications channel over which the transmitting station transmits its data. The identification signal can for example be transmitted by a receiving station, which is ready to receive the data from the transmitting station. With the free data transmission capacity can be expressed, that the data transmission channel is not used in a required time frame for transmitting other data.

According to one embodiment, the method may comprise a step of checking an existence of the free data transmission capacity of the data transmission channel. Accordingly, the transmission of the data may take place when the step of checking shows that the free data transmission capacity of the data transmission channel exists. The step of checking can be, for example, performed by a receiving station. The receiving station can execute the step of checking repeatedly or over a predetermined time. According to this embodiment, a possible collision of the data with other data, which are transmitted simultaneously via the data transmission channel, can be effectively prevented.

The method can also comprise a step of analyzing the identification signal with respect to a code which the transmitting station uniquely identifies as a transmitting station, from which the data is to be send. The step of analyzing can be performed by the transmitting station. Thus it can be ensured in a simple manner that the transmitting station sends out the data only when it is needed by a receiving station. Advantageously, the data transmission channel can be protected against overload caused by unnecessary data traffic.

Furthermore, the method can comprise a step of evaluating the identification signal when a message to be sent is present in the transmitting station. Thus, in many cases scarce energy reserves of the transmitting station can be favorably protected because the transmitting station can ignore the identification signal if no data to be sent exists.

In a method for transmitting an identification signal from a receiving station by means of a data transmission channel, the identification signal represents information about a free data transmission capacity of the data transmission channel.

The receiving station can be for example a device that is configured to receive data from a transmitting station explained according to the preceding embodiments in order to perform a certain action. Regardless of this, the receiving station can also be configured to send data. The transmission of the identification signal can be performed by radio in a predetermined frequency range. The identification signal may be a radio signal that can be transmitted by the receiving station through the same data transmission channel through which it can receive the data from a transmitting station. The identification signal can be for example transmitted by the receiving station to a transmitting station, from which the receiving station needs data. The data transmission channel can be one of several frequency bands in the frequency range, which are suitable for transmission of the data. With the free data transmission capacity can be expressed that the data transmission channel is not occupied by transmitting other data in a time slot required for the transmission of data from the transmitting station to the receiving station.

According to an embodiment, the method can comprise a step of checking the data transmission channel for a free data transfer capacity. In this case, the duration and/or a frequency of checking can be higher than the duration and/or a frequency of an expected checked time slot of a transmitting station. For example, the step of checking can be executed by the receiving station. This embodiment advantageously uses the fact that the receiving station generally has more electrical energy available than one of the transmitting stations. Thus the checking on data transmission capacity can be carried out in a more comprehensive and gapless manner. At the same time, the transmitting station usually equipped with less energy reserves can save energy by access to the check of the receiving station, because there is no longer required here a check of the data transmission capacity.

For example, the identification signal may be adapted to reserve the data transmission channel during the transmission of the identification signal for sending data from at least one of the transmitting stations associated to the receiving station. Thus it can be readily ensured that the data transmission between the receiving station and its associated transmitting station is not disturbed by a data transmission of other participants communicating in the same frequency range.

According to a further embodiment, the method can comprise a step of encoding the identification signal to identify, by means of the encoded identification signal, a first transmitting station associated with the receiving station and/or at least a second transmitting station associated with the receiving station for sending out data. The first transmitting station and/or the second transmitting station can be assigned different functions and/or different priorities. It is thus possible to deploy in a simple manner a number of receiving stations, which can simultaneously request different data.

In particular, the data and/or the identification signal can be transmitted in an ISM band. Thus, the data and the identification signal can be advantageously sent without the payment of royalties.

Advantageous is also a computer program product with a program code which may be stored on a machine-readable medium such as a semiconductor memory, a hard disk memory or an optical memory, and is used for carrying out a method according to one of the embodiments described above, when the program is executed on a computer or a device.

A transmitting station for transmitting the data by means of a data transmission channel is adapted to transmit the data in response to an identification signal that represents information about a free data transfer capacity of the data transmission channel.

The transmitting station and the receiving station can be configured to perform or implement the steps of the method according to the invention in the corresponding devices. These embodiments of the invention in the form of the transmitting station and the receiving station can resolve quickly and efficiently the object of the invention.

The transmitting station and the receiving station can be devices referred to as electrical devices, which process the sensor signals and in response output control signals. A device can comprise one or more suitable interface, which can be formed by the hardware and/or by software. In a hardware configuration, the interfaces can be for example part of an integrated circuit, in which the functions of the device are implemented. The interfaces can also be separate, integrated circuits or, at least partially, be comprised of discrete components. In a software configuration, the interfaces can be software modules that are present, for example, on a microcontroller in addition to other software modules.

The invention is explained in more detail by way of example with reference to the accompanying drawings. The figures show:

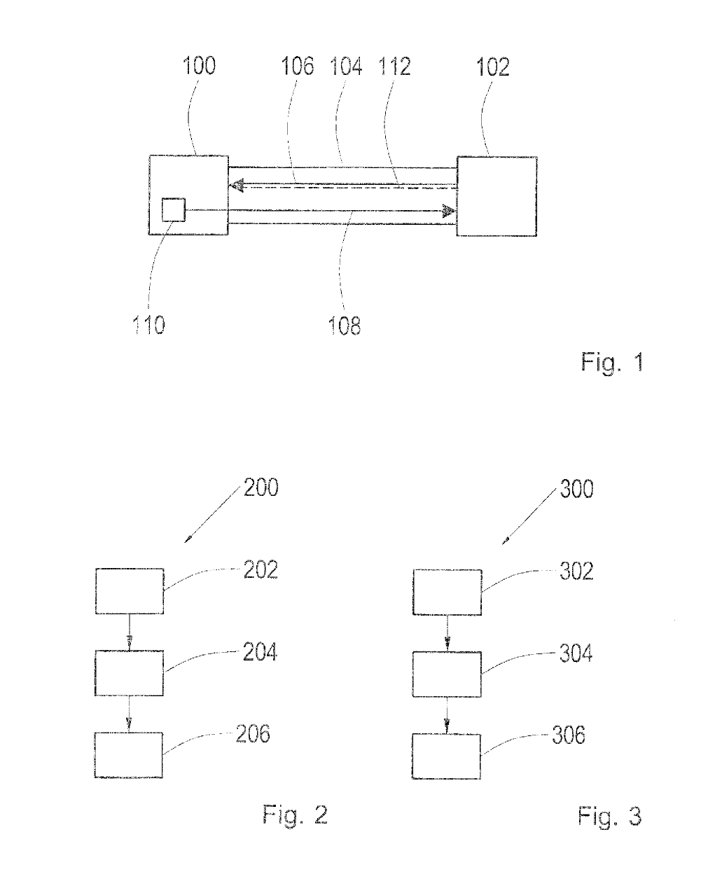

FIG. 1 shows a representation of a data communication system via radio with the transmitting station according to an embodiment of the present invention and a receiving station according to an embodiment of the present invention.

FIG. 2 is a flowchart of a method for sending data from a transmitting station according to an embodiment of the present invention; and

FIG. 3 is a flow diagram of a method for transmitting an identification signal from a receiving station according to an embodiment of the present invention.

In the following description of preferred embodiments of the present invention, the same or similar reference numerals are used for the elements shown in the various figures and acting similarly, while repeated description of these elements is dispensed with.

Wireless switches, where the switch actuation is used for local energy production, usually provide only a very short-lived voltage pulse, lying in the millisecond range. Since every form of energy storage—by means of capacities—relatively quickly loses energy in the given context, it is desirable that the data to be transmitted by the radio signal be sent as quickly as possible.

The solution to this problem shall be explained by means of the invention presented here with reference to the subsequent figures.

FIG. 1 shows a schematic diagram for explaining a system for data communication via radio. According to an embodiment shown in FIG. 1, the system is formed by a transmitting station 100 and a receiving station 102, which communicate with each other via a data transmission channel 104. The transmitting station 100 is here a wireless switch and the receiving station 102 is an electrical device such as a lighting device. The transmitting station 100 and the receiving station 102 can alternatively be other devices for data communication via radio. The transmitting station 100 is configured to transmit data via the data transmission channel 104 to the receiving station 102 and the receiving station 102 is configured to transmit an identification signal over the data transmission channel 104 to the transmitting station 100.

The system shown in FIG. 1 operates in the frequency range of the ISM band. In alternative embodiments, the system can also be used in other frequency ranges. The initially described LBT protocol is used in a modified form according to the invention.

In the system shown in FIG. 1, the receiving station 102 is adapted to perform an action based on the data received from the transmitting station 100. Accordingly, the receiving station 102 is configured to check whether the data transmission channel 104 has a free space so that the transmitting station 100 can transmit the required data freely to the receiving station 102. For this purpose, the receiving station 102 checks the data transmission channel 104 in regular intervals for a predetermined time. If a free data transmission capacity is determined, the receiving station 102 sends through the transmission channels 104 identification signal 106 representing the free data transmission capacity to the transmitting station 100.

In response to the reception and, where appropriate, an evaluation of the identification signal 106, the transmitting station 100 transmits data 108 to the receiving station 102 so that it can carry out a required action based on the data 108, for example, the activation of an illuminator coupled to the receiving station 102. According to the invention, the transmitting station 100 can send data 108 without having to check the data transmission channel 104 for free capacity, because this has already been done by the receiving station 102.

In the embodiment shown in FIG. 1 the transmitting station 100 evaluates the identification signal 106 transmitted by the receiving station 102 only, because a message 110 is present in the transmitting station 100, which must be transmitted by means of the data 108 to the receiving station 102. Otherwise, in this embodiment the transmitting station 100 ignores the identification signal 106. For example, the identification signal 106 has a suitable length to “reserve” the data transmission channel 104 during the sending of the identification signal 106 for the transmission of data 108 from the transmitting station 100 and to block the sending of data by other participants in the system.

In the embodiment shown in FIG. 1, the identification signal 106 is provided with a code 112 marked by a dashed line to clearly identify the transmitting station 100 as the station, from which the receiving station 102 expects or requires a data transmission. The transmitting station 100 is configured accordingly to analyze the received identification signal 106 with respect to the code 112, and not to output the data 108 until the transmitting station 100 feels entitled to output the data 108 based on the code analysis.

Regardless of the reception of the identification signal 106, the transmitting station is configured according to the embodiments to listen into the data transmission channel 104 and check it for free data transmission capacity. Thus, the transmitting station 100 can also send the data 108 regardless of the reception of the identification signal 106.

The wireless switch in FIG. 1 forming the transmitting station 100 and also the target receiving station 102 and possibly other receiving stations are designed for bidirectional data exchange, it being noted that the receiving station 102 has significantly more energy available and—what is still more important—this energy is there permanently available.

As already mentioned, in accordance with the embodiment shown in FIG. 1, the spark-initiated wireless control connection of the wireless switch 100 according to the invention—always only very briefly—listens into the channel 104 before sending. However, it sends not only if the data transmission channel 104 is free, but preferably even if it receives the identification or the identification signal 106 from the channel 104, which is sent by the target receiving station 102 as a “beacon signal”.

In this inventively modified LBT protocol, the receiving station 102, which is equipped with a comfortable reserve of energy, takes over the essential work of the relatively energy-intensive “listening-into-the-channel”. As part of the rules naturally also applicable to the receiving station 102, for example, the 1%-duty-cycle rule in the 868 MHz band, this receiving station checks—for example, by a relative frequent “listening-into-the-channel”—the channel assignment and so can detect the free channel 104. As already mentioned, the receiving station 102 can in a certain sense immediately occupy the channel also for “its wireless switch” 100 by transmitting the identification signal 106 in a suitable length for the time of this identification transmission. Incidentally, the concept presented here can be used also in other ISM bands, e.g. 2.45 GHz, while respecting the rules applicable there.

With the signal 106 emitted by it, the receiving station 102 is signaling like a lighthouse to the wireless switch 100 waiting with the message 110 in the sense of a statement of “Here I am, I am ready to receive—please send”. The wireless switch 100 thus “knows”—namely, by its own “listening-into-the-channel”—that it can send now. The impetus for transmission thus occurs either in that the wireless switch 100 itself finds the channel 104 free, or by the recognition of the “lighthouse signal” 106. In the latter case also without the wireless switch 100 having to listen into the channel 104 again; it can now send its message 110 without further delays. The condition according to the embodiment shown in FIG. 1 is that a message 110 to be sent is present in the wireless switch 100.

A conventional LBT protocol, which is not equipped with the “lighthouse function”, can continue to be used in this arrangement and can just as well as before ensure the transmission according to the current state of the art. However, the additional possibility to use the identification signal 106 coming from the “lighthouse” 102 as a trigger for the transmission of the data 108 significantly expands the possibility of using wireless switches.

A longer “listening-into-the-channel” by the wireless switch 100 is according to the invention no longer necessary, and the corresponding required reception power can be kept low.

In the given radio channel 104 each participant is equal. Who sends simply, is allowed to do so; disturbances must be simply statistically scheduled. However, the “lighthouse signal” 106 can for example activate specific groups of wireless switches. If for example two switch groups with possibly a different priority are associated with two different functions, then one or more adjacent receivers can each contact one of the switch groups with their identification signal. Several “lighthouses” 102 can thus work in a cooperative and priority-defined manner.

FIG. 2 shows a flow diagram of an embodiment of a method 200 for transmitting data from a transmitting station by means of a data transmission channel. In a step 202, the transmitting station receives from a receiving station an identification signal that represents information about a free data transfer capacity of the data transmission channels.

In a step 204 the transmitting station analyzes the identification signal with respect to a code that uniquely identifies the transmitting station as the transmitting station authorized to transmit. If the analysis made in step 204 shows that the transmitting station is authorized for data transmission to the receiving station, in a step 206 the transmitting station sends the data by means of the data transmission channels the receiving station.

FIG. 3 shows a flow diagram of an embodiment of a method 300 for transmitting an identification signal representing a free data transmission capacity of a data transmission channel from a receiving station. In a step 302, the receiving station checks the data transmission channel for a free data transmission capacity. If the step 302 determines that a free data transmission capacity is present, the receiving station encodes the identification signal in a step 304 with a code to ensure that the identification signal can be received and used only by a transmitting station authorized to transmit, and sends in a step 306 the encoded identification signal via the data transmission channel.

The term “transmitting station” 100 as used in FIGS. 1 to 3 can be understood as an autonomous wireless switch, for example, an autonomous sensor or a wireless switch. These terms can be seen here as synonyms for the stations that want to transmit data to a receiving station, whilst also representing the broader scope of the invention; this does not exclude in the (bidirectional) radio protocol that this “transmitting station” 100 can also receive in order to for example “listen into the channel”.

The term “receiving station” 102 as used in FIGS. 1 to 3 can be understood, for example, as a receiver or another “receiving elements”. These terms should be regarded as synonyms for the station, which receives data from a transmitter, and they also represent the broader scope of the invention. This does not exclude in the (bidirectional) radio protocol that the “receiving station” 102 can also send to for example excite a wireless switch to emit its data.

The embodiments described and shown in the figures are chosen only by way of example. Different embodiments may be combined in whole or with regard to individual features. An embodiment can also be supplemented by features of another embodiment.

Furthermore, the process steps according to the invention can be repeated and executed in a different sequence than that described.

If an embodiment comprises a connection “and/or” between a first feature and a second feature, this can be read so that the embodiment according to one form comprises both the first feature and the second feature and according to a further form comprises either only the first feature or the second feature.

### REFERENCE NUMERALS

100 Transmitting station
102 Receiving station
104 Data transmission channel
106 Identification signal
106 Data transmission channel
108 Data
110 Message to be sent
112 Code
200 Procedure for sending data
202 Step of receiving an identification signal
204 Step of analyzing the identification signal
206 Step of sending data
300 Procedure for sending an identification signal
302 Step of checking the data transmission channel for a free data transmission capacity
304 Step of encoding the identification signal
306 Step of sending the identification signal

1. A method for transmitting data from a transmitting station via a data transmission channel;
wherein the data are emitted in response to an identification signal;
wherein the identification signal represents the information about a free data transmission capacity of the data transmission channels.

2. The method of claim 1, wherein the method comprising checking an existence of the free data transmission capacity of the data transmission channel, wherein the transmission of the data occurs when the checking shows that the free data transmission capacity of the data transmission channel exists.

3. The method of claim 1, wherein the method further comprises analyzing the identification signal with respect to a code which uniquely identifies the transmitting station as a transmitting station, from which the data are to be sent.

4. The method of claim 3, wherein the method further comprises evaluating the identification signal, if a message to be sent out exists in the transmitting station.

5. A method for transmitting an identification signal from a receiving station via data transmission channels;
wherein the identification signal represents information about a free data transfer capacity of the data transmission channel.

6. The method of claim 5, wherein the method comprises checking the data transmission channels for a free data transmission capacity;
and wherein a duration and/or a frequency of checking is higher than a duration and/or a frequency of checking an expected time slot of the transmitting station.

7. The method of claim 5, wherein the identification signal is adapted to reserve the data transmission channel during the emission of the identification signal for a transmission of data from at least one of the receiving station associated with the transmitting station.

8. The method of claim 5, wherein the method comprises encoding the identification signal for identifying by means of the encoded identification signal a first transmitting station associated with the receiving station and/or at least a second transmitting station associated with the receiving station for transmitting data, wherein different functions and/or different priorities can be assigned to the first transmitting station and/or the second transmitting station.

9. The method of claim 1, wherein the data and/or the identification signal is sent out or received in an ISM frequency range.

10. A computer program product with a program code for performing the method of claim 1 when the program product is executed on a device.

11. A transmitting station for transmitting data by means of a data transmission channel, wherein the transmitting station is configured to send out the data in response to an identification signal which represents information about a free data transfer capacity of the data transmission channel.

12. A receiving station for emitting an identification signal via a data transmission channel; wherein the identification signal represents information about a free data transmission capacity of the data transmission channel.

13. The method of claim 2, wherein the method further comprises analyzing the identification signal with respect to a code which uniquely identifies the transmitting station as a transmitting station, from which the data are to be sent.

14. The method of claim 13, wherein the method further comprises evaluating the identification signal, if a message to be sent out exists in the transmitting station.

15. The method of claim 6, wherein the identification signal is adapted to reserve the data transmission channel during the emission of the identification signal for a transmission of data from at least one of the receiving station associated with the transmitting station.

16. The method of claim 6, wherein the method further comprises encoding the identification signal for identifying by means of the encoded identification signal a first transmitting station associated with the receiving station and/or at least a second transmitting station associated with the receiving station for transmitting data, wherein different functions and/or different priorities can be assigned to the first transmitting station and/or the second transmitting station.

17. The method of claim 7, wherein the method comprises encoding the identification signal for identifying by means of the encoded identification signal a first transmitting station associated with the receiving station and/or at least a second transmitting station associated with the receiving station for transmitting data, wherein different functions and/or different priorities can be assigned to the first transmitting station and/or the second transmitting station.

18. The method of claim 5, wherein the data and/or the identification signal is sent out or received in an ISM frequency range.

19. A computer program product with a program code for performing the method of claim 5 when the program product is executed on a device.

20. A computer program product with a program code for performing the method of claim 9 when the program product is executed on a device.
